(19) United States
(12) Patent Application Publication
(10) Pub. No.: US 2018/0063465 A1
(43) Pub. Date: Mar. 1, 2018

(54) LARGE VIDEO DISPLAY WITH HANDLE

(71) Applicant: Sony Corporation, Tokyo (JP)

(72) Inventor: Brian Joosung Kim, San Diego, CA (US)

(21) Appl. No.: 15/388,031

(22) Filed: Dec. 22, 2016

Related U.S. Application Data
(60) Provisional application No. 62/382,400, filed on Sep. 1, 2016.

(51) Int. Cl. H04N 5/64; A45F 5/10

(52) U.S. Cl. CPC H04N 5/64; A45F 5/10

(57) ABSTRACT

To reduce damages to a video display when removing the display from a box, one or more handles are engaged with the back surface of the display. The handle includes a mount plate flat against the back surface and mounted thereto and a grip pivotably engaged with the mount plate for movement from a flat configuration, in which the grip is coplanar with the mount plate, and a gripping configuration, in which the grip is not coplanar with the mount. The grip defines an opening for facilitating grasping the grip.

### FIELD

The present application relates to video displays with handles.

### BACKGROUND

Modern video displays such as large flat screen high definition and ultra high definition displays can be damaged when a buyer extracts the display from its box. Typically, people grasp the display strongly enough to be able to lift the relatively large and heavy display out of the box, which sometimes results in damage to the screen.

### SUMMARY

Accordingly, an assembly includes a video display defining a back surface, and at least a first handle engaged with the back surface. The first handle has a mount plate flat against the back surface and mounted thereto, and a grip pivotably engaged with the mount plate for movement from a flat configuration, in which the grip is coplanar with the mount plate, and a gripping configuration, in which the grip is not coplanar with the mount plate. The grip defines an opening for facilitating grasping the grip.

In some embodiments, a second handle may be engaged with the back surface and spaced from the first handle. The second handle can be substantially identical in configuration to the first handle.

The grip may be made unitarily with the mount plate and may be pivotable relative to the mount plate about a living hinge formed between the grip and the mount plate. In some arrangements, in the flat configuration the grip is vertically above the mount plate relative to a top edge of the display. In other arrangements, in the flat configuration the mount plate is inboard of the grip such that a centerline of the handle from a center of the mount plate through a center of the grip is parallel to a top edge of the display.

The opening of the grip may be rectilinear, triangular, L-shaped, or other suitable shape.

In some examples an elongated bar connects the first handle to the second handle. Moreover, if desired left and right handles may be respectively closely juxtaposed with the first and second handles having respective grips vertically above respective mount plates. However, each of the left and right handles can have respective grips laterally positioned with respect to respective mount plates.

In some examples, a single unitary mount plate assembly connected to the first and second handles.

In another aspect, a method includes providing at least a first handle on a back surface of a video display. The first handle has a mount plate flat against the back surface and mounted thereto, and a grip pivotably engaged with the mount plate for movement from a flat configuration, in which the grip is coplanar with the mount plate, and a gripping configuration, in which the grip is not coplanar with the mount plate. The grip defines an opening for facilitating grasping the grip. The method includes disposing the display in a box with the handle in the flat configuration.

In another aspect, an assembly comprises at least a first handle engageable with a video display. The first handle has a mount plate for lying flat against the back surface and for mounting thereto, and a grip pivotably engaged with the mount plate for movement from a flat configuration, in which the grip is coplanar with the mount plate, and a gripping configuration, in which the grip is not coplanar with the mount plate, the grip defining an opening for facilitating grasping the grip.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a perspective view of a first type of handle on the rear surface of a display, with the handles in the flat configuration;

FIG. 2 is a perspective view of the handles in FIG. 1 in the gripping configuration;

FIG. 3 is a perspective view of a second type of handle on the rear surface of a display, with the handles in the flat configuration;

FIG. 4 is an elevational view of a third type of handle in the flat configuration, with the display not shown;

FIG. 5 is a perspective view of a fourth type of handle on the rear surface of a display, with the handles in the gripping configuration;

FIG. 6 is a perspective view of a fifth type of handle in the flat configuration, with the display not shown; and

FIG. 7 is a perspective view of a sixth type of handle in the flat configuration, with the display not shown.

### DETAILED DESCRIPTION

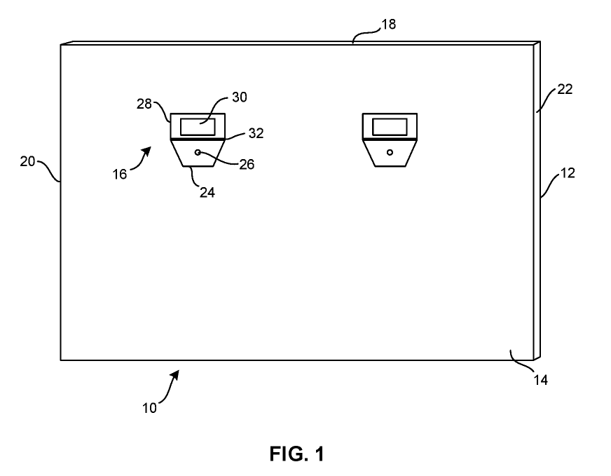

FIG. 1 shows a video display 10 such as but not limited to a high definition or ultra-high definition “4K” or higher flat screen and that may or may not be touch-enabled for receiving user input signals via touches on the display. The display 10 has a video screen 12 and opposed to and generally parallel to the screen 12, a rear surface 14.

One or more handles 16 are engaged with the rear surface 14. In the example of FIG. 1, two handles 16 are engaged with the rear surface 14 near a top edge 18 of the display 10, spaced from each other as shown such that one handle 16 is closer to the left edge 20 of the display while the other handle 16 is closer to the right edge 22. Both handles 16 in the example shown are spaced the same or substantially the same distance from the top edge 18 as shown.

The handles 16 may be made of injection-molded plastic and may be colored brightly, such as white, for ease of visual identification.

In the example of FIG. 1, each handle 16 includes a mount plate 24 that may be attached to the rear surface 14 by, for example, a threaded fastener 24. The non-limiting example shape of the mount plates 24 may be trapezoidal, although other shapes may be employed.

Each handle 16 also includes a grip 28 connected to the mount plate 24. The grip 28 may be shaped as a rectangle, although other shapes may be employed. Each grip 28 can include an opening 30 that a person can slip part of his hand through to grasp the grip 28. In the example shown, the opening 30 is rectangular, although other shapes such as ovular can be used.

In preferred embodiments the grip 28 may be made unitarily with the mount plate 24 and may be pivotable relative to the mount plate 24 about a living hinge 32 formed between the grip 28 and mount plate 24. Accordingly, each handle 16 can assume a flat configuration as shown in FIG. 1, in which both the mount plate 24 and grip 28 are flush against the back surface 14 and are generally co-planar with other. In this configuration, the handle presents a low profile on the display and thus is shipped in a box in this configuration.

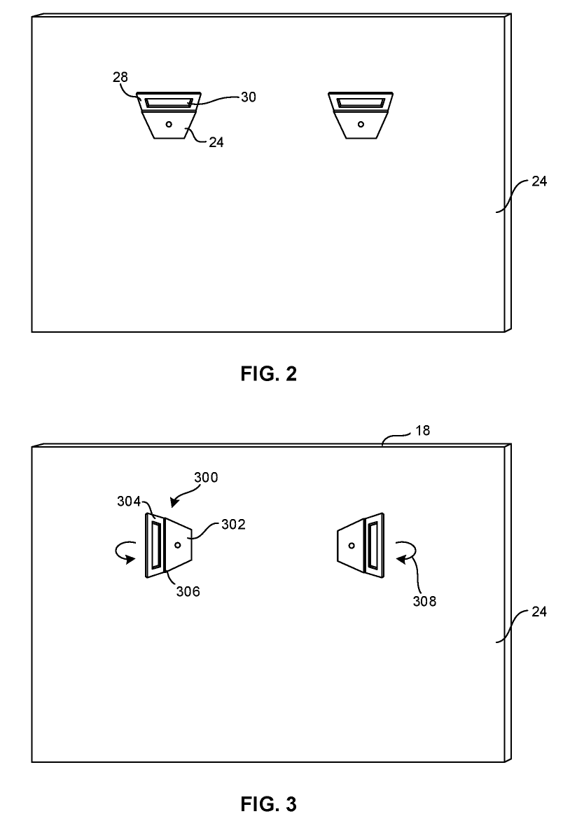

Also, each handle 16 can be moved to a gripping configuration as shown in FIG. 2, in which the mount plate 24 remains flush against the back surface 24 but the grip 28 is pivoted away from the back surface to facilitate ease of grasping through the opening 30.

In the example shown in FIGS. 1 and 2, in the flat configuration the grip 28 is vertically above the associated mount plate 24, relative to the top edge 18 of the display. Such an arrangement facilitates lifting the display 10 vertically out of a box.

In contrast, as shown in FIG. 3, handles 300 that are substantially identical in shape and construction to the handles 16 shown in FIG. 1 may be mounted to the back surface 24 of the display with mount plates 302 inboard of their respective grips 304. Thus, the centerline of each handle 300 from the center of the mount plate through the center of the grip is parallel to the top edge 18 of the display, whereas in the arrangement shown in FIGS. 1 and 2 the handle 16 centerline is perpendicular to the top edge. The grips 304 may be pivoted about living hinges 306 as indicated by the arrows 308 to facilitate ease of grasping through the opening of the handle. Such an arrangement facilitates lifting the display 10 side way out of a box.

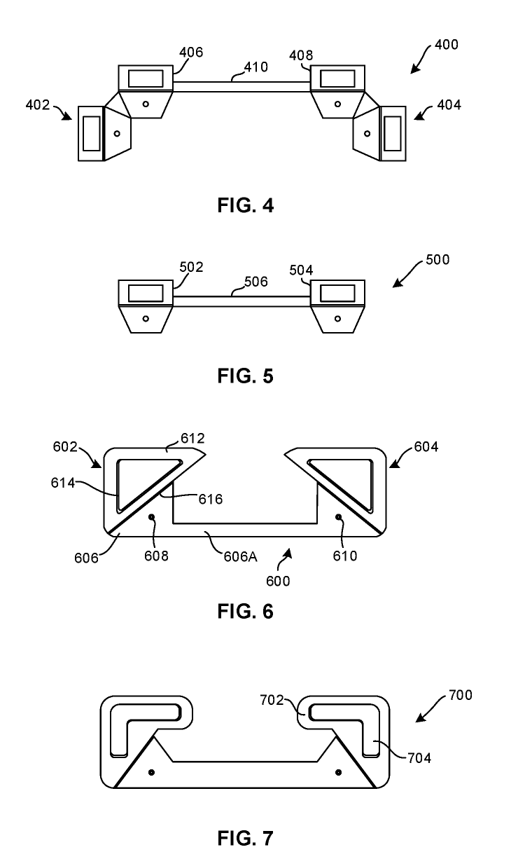

FIG. 4 shows another handle assembly 400 in which left and right handles 402, 404 are closely juxtaposed with first and second top handles 406, 408, combining the qualities of the embodiments shown in FIGS. 1-3. The grip of each handle in FIG. 4 can be pivoted away from the flat configuration shown to facilitate grasping the handle. In the example of FIG. 4, the first and second top handles 406, 408 may be connected to each other by an elongated plastic bar 410, which establishes an additional gripping surface particularly useful when lifting the display upward.

FIG. 5 shows an assembly 500 that is substantially identical to the assembly 400 of FIG. 4, without the left and right handles and with only first and second top handles 502, 504 connected by an elongated bar 506.

FIG. 6 shows a handle assembly 600 with left and right grips 602, 604 spaced from each other and connected to each other by a single mount plate 606 with integral connecting bar 606A. The mount plate 606 may have left and right fastener holes 608, 610 for mounting the mount plate 606 to the rear surface of a display. In the example shown, each grip 612 is triangular and has a triangular opening 614, and may be pivotable relative to the mount plate 606 along a living hinge 616.

FIG. 7 shows an assembly 700 that in all essential respects is identical to the assembly 600 in FIG. 6, except that the grips 702 are generally L-shaped and have L-shaped openings 704. The corners of the grips and openings herein may be gently rounded for comfort as shown in FIG. 7. Likewise, the edges of the grip openings may be rounded or beveled for comfort.

While particular techniques and machines are herein shown and described in detail, it is to be understood that the subject matter which is encompassed by the present invention is limited only by the claims.

What is claimed is:

1. An assembly, comprising:
a video display defining a back surface; and
at least a first handle engaged with the back surface, the first handle comprising:
a mount plate flat against the back surface and mounted thereto; and
a grip pivotably engaged with the mount plate for movement from a flat configuration, in which the grip is coplanar with the mount plate, and a gripping configuration, in which the grip is not coplanar with the mount plate, the grip defining an opening for facilitating grasping the grip.

2. The assembly of claim 1, comprising at least a second handle engaged with the back surface and spaced from the first handle.

3. The assembly of claim 2, wherein the second handle comprises:
a mount plate flat against the back surface and mounted thereto; and
a grip pivotably engaged with the mount plate for movement from a flat configuration, in which the grip is coplanar with the mount plate, and a gripping configuration, in which the grip is not coplanar with the mount, the grip defining an opening for facilitating grasping the grip.

4. The assembly of claim 1, wherein the grip is made unitarily with the mount plate and is pivotable relative to the mount plate about a living hinge formed between the grip and the mount plate.

5. The assembly of claim 1, wherein in the flat configuration the grip is vertically above the mount plate relative to a top edge of the display.

6. The assembly of claim 1, wherein in the flat configuration the mount plate is inboard of the grip such that a centerline of the handle from a center of the mount plate through a center of the grip is parallel to a top edge of the display.

7. The assembly of claim 1, wherein the opening is rectilinear.

8. The assembly of claim 1, wherein the opening is triangular.

9. The assembly of claim 1, wherein the opening is L-shaped.

10. The assembly of claim 2, comprising an elongated bar connecting the first handle to the second handle.

11. The assembly of claim 2, comprising left and right handles respectively closely juxtaposed with the first and second handles having respective grips vertically above respective mount plates, each of the left and right handles having respective grips laterally positioned with respect to respective mount plates.

12. The assembly of claim 2, comprising a single unitary mount plate assembly connected to the first and second handles.

13. A method comprising:
providing at least a first handle on a back surface of a video display, the first handle comprising:
a mount plate flat against the back surface and mounted thereto; and
a grip pivotably engaged with the mount plate for movement from a flat configuration, in which the grip is coplanar with the mount plate, and a gripping configuration, in which the grip is not coplanar with the mount plate, the grip defining an opening for facilitating grasping the grip; and
disposing the display in a box with the handle in the flat configuration.

14. An assembly, comprising:
at least a first handle engageable with a video display, the first handle comprising:
a mount plate for lying flat against the back surface and for mounting thereto; and
a grip pivotably engaged with the mount plate for movement from a flat configuration, in which the grip is coplanar with the mount plate, and a gripping configuration, in which the grip is not coplanar with the mount plate, the grip defining an opening for facilitating grasping the grip.

15. The assembly of claim 14, comprising at least a second handle engageable with the back surface in a spaced relationship with the first handle.

16. The assembly of claim 14, wherein the grip is made unitarily with the mount plate and is pivotable relative to the mount plate about a living hinge formed between the grip and the mount plate.

17. The assembly of claim 14, wherein the opening is rectilinear.

18. The assembly of claim 14, wherein the opening is triangular.

19. The assembly of claim 14, wherein the opening is L-shaped.

20. The assembly of claim 15, comprising an elongated bar connecting the first handle to the second handle.
